(19) United States
(12) Patent Application Publication
(10) Pub. No.: US 2022/0267910 A1
(43) Pub. Date: Aug. 25, 2022

(54) Method for constructing micro-nano porous organic acid pretreatment layer on metal surface and its application

(71) Applicant: Zhejiang University, Hangzhou, Zhejiang (CN)

(72) Inventors: Jiming Hu, Hangzhou, Zhejiang (CN); Yue Zhao, Hangzhou, Zhejiang (CN)

(21) Appl. No.: 17/634,222

(22) PCT Filed: Jan. 1, 2021
(86) PCT No.: PCT/CN2021/070054

§ 371 Date: Feb. 9, 2022

(30) Foreign Application Priority Data
Jan. 15, 2020 (CN) 202010043891.4

(51) Int. Cl. C23F 1/16; C23C 22/48

(52) U.S. Cl. CPC C23F 1/16; C23C 22/48

(57) ABSTRACT

A method for constructing a micro-nano porous organic acid pretreatment layer on the metal surface and its application are provided. A pretreatment reagent used is prepared by chemically grafting organic acid with hydroxylation-rich polymer. After immersed in the pretreatment reagent for a period of time, the metal substrates are then dried and cured, and the organic acid pretreatment layer with a micro-nano porous structure and excellent adhesion is successfully formed. The present invention provides the pretreatment reagent and pretreatment process of the metal surface coating protection technology. The solvent is only pure water and realizes no organic solvation. The pretreatment layer has excellent adhesion with the metal substrate, rough and porous structure, and can be closely interlocked with the subsequent coating layer, which greatly enhances the anticorrosion performance of the whole coating system.

### BACKGROUND OF THE PRESENT INVENTION

### Field of Invention

The present invention relates to metal pretreatment technology, in particular to a method and application for constructing a micro-nano porous organic acid pretreatment layer on a metal surface.

### Description of Related Arts

Metals are indispensable in daily life. However, except for a few precious inert metals (platinum, gold, etc.), most metals and their alloys are relatively easy to corrode under natural conditions and cause losses. Coating protection is the most used and effective one among various anti-corrosion methods. The metal surface coating system is mainly composed of two parts: the metal surface pretreatment layer and the subsequent coating. Conventional pretreatment technologies such as chromate passivation and inorganic phosphate passivation will cause harm to the environment, such as highly toxic hexavalent chromium ions and eutrophication of water bodies. In order to develop a new type of environmentally friendly surface treatment technique, silanization of metal surfaces and organic acid passivation have been gradually promoted in the past decade. However, it is difficult for silylation reagents to realize that all the solvents are water, and the mixed organic solvents make it difficult to meet environmental protection standards. In addition, the silane solution is affected by its own hydrolysis and polycondensation, is not easy to be stable for a long time, and is prone to failure, which increases the cost and causes environmental pollution to a certain extent. In addition, with a simple organic acid passivation process, the metal surface can often only reach nano-level roughness, the porosity is not obvious, the bonding performance with the subsequent coating is not significantly improved, and the protection performance is not ideal.

### SUMMARY OF THE PRESENT INVENTION

The purpose of the present invention is to make up for the shortcomings of the prior art, and propose a method and application for constructing a micro-nano porous organic acid pretreatment layer on a metal surface.

The purpose of the present invention is achieved through the following technical procedures:

A method for constructing an organic acid pretreatment layer with a micro-nano porous structure on a metal surface comprises steps of:

1) refluxing a hydroxyl-rich polymer and an organic acid in water, and after cooling to room temperature, adding a corrosion inhibitor to prepare a pretreatment reagent prior to use;

2) after a metal substrate is polished and degreasing, immersing the metal substrate in a pretreatment test solution for pretreatment; after drying and solidification, removing excess pretreatment test solution by washing with water to obtain the organic acid pretreatment layer with the micro-nano porous structure on the metal surface; and

3) preparing a subsequent coating on the organic acid pretreatment layer.

In some embodiments, the hydroxyl rich polymer in the step 1) is one or more of water-soluble polyethylene glycol, polyvinyl alcohol, polymethylcellulose, etc.

In some embodiments, the organic acid in the step 1) is one or more of phytic acid, tannic acid and hydroxyethylidene diphosphonic acid with strong chelating coordination with metal.

In some embodiments, a reflux reaction temperature in the step 1) is 70-100° C., and the reflux reaction time is 3-8 hours.

In some embodiments, the corrosion inhibitor in the step 1) is one or more of urotropine, thiourea, benzotriazole, polyvinylpyrrolidone, zinc gluconate, and sodium metavanadate.

In some embodiments, a pretreatment temperature in the step 2) is 20-60° C., and a treatment time is 0.5-15 min; a drying curing temperature is 40-60° C., and a time is 10-30 min.

In some embodiments, the applicable metals are iron, aluminum, zinc, copper, magnesium, and alloys of the foregoing metals.

In some embodiments, the subsequent coating prepared on the pretreatment layer in step 3) comprises coating epoxy, polyurethane, alkyd, and polyacrylic acid.

In some embodiments, the organic acid pretreatment layer has a micro-nano porous structure and is prepared by this method.

Beneficial effects of the present invention: Compared with the conventional metal surface coating system, the pretreatment layer with a micron-level rough structure prepared by the present invention has excellent protection performance, strong environmental protection, and realizes no organic solvation. The method is simple, only requires dip coating, does not require power or high temperature conditions, and has no selectivity for subsequent coatings. It is a universal, facile and environmentally friendly pretreatment technology. The pretreatment test solution used in the present invention is obtained by reflux grafting of organic acid and hydroxyl-rich polymer in aqueous solution. Organic acids are environmentally friendly acids such as phytic acid, tannic acid, and hydroxyethylidene diphosphonic acid. The solvent of the pretreatment test solution is all water and does not contain organic solvents. The graft-modified product has high stability and can be stored for a long time without worrying about failure. The pretreatment technology is simple, no need to power up or high reaction temperature, suitable for all kinds of complex workpieces and a variety of metals. The use of organic acids that have strong chelation and coordination with metals, the pretreatment layer has excellent binding force with the metal substrate, and the use of polymer for grafting makes the pretreatment layer highly flexible, which can improve the impact resistance of subsequent coatings. In addition, the pretreatment layer is rough, porous and rich in hydroxyl groups, and has good bonding force with subsequent coatings.

### BRIEF DESCRIPTION OF THE DRAWINGS

FIG. 1 is an SEM photo of carbon steel/tannic acid-PVA; and

FIG. 2 is an SEM photograph of carbon steel/tannin acid.

### DETAILED DESCRIPTION OF THE PREFERRED EMBODIMENT

The present invention will be further illustrated with the accompanying drawings and embodiments.

Implementation comprises the following steps of:

1) combining one or more polymers such as water-soluble polyethylene glycol, polyvinyl alcohol, polymethyl cellulose, etc. with organic acids (such as phytic acid, tannic acid, hydroxyethylidene diphosphonic acid); refluxing a volume of water at 70˜100° C., 3-8 hours, and cooling to room temperature, adding a certain amount of urotropine, thiourea, benzotriazole, polyvinylpyrrolidone, zinc gluconate, sodium metavanadate; waiting for one or more of the corrosion inhibitors to prepare pretreatment reagents for use;

2) after a metal is polished and degreasing, immersing in a pretreatment test solution for a period of time under a certain temperature environment, taking the metal out and drying and solidifying at 40-60° C. for 10-30 minutes, after solidification, immersing in water several times to remove excess acid liquid to obtain the metal with an organic acid pretreatment layer with a micro-nano porous structure, ready for use; and

3) processing the pretreated metal with dipping, spraying and other methods, such as epoxy, polyurethane, alkyd, polyacrylic and other subsequent coatings.

The pretreatment layer with micron-level rough structure prepared by the present invention has excellent protective performance, strong environmental protection, simple method, only needs dip coating, and has no selectivity to subsequent coatings. It is a universal, simple and environmentally friendly pretreatment technology, which has the prospect of large-scale industrial application.

### Embodiment 1

It is prepared by reflux method. 100 mL water, 2 g tannic acid (TA, Aladdin Chemical Reagent Co., Ltd.), 1 g polyvinyl alcohol type 1799 (Macklin Chemical Reagent Co., Ltd.) are mixed and refluxed for 5 hours at 85° C. The product is cooled to room temperature after refluxing. The polished and degreased Q235 carbon steel is immersed in the prepared pretreatment test solution for 30 s at 25° C., and then taken out. Put it in an oven at 45° C. to cure for 30 minutes. After curing, it is repeatedly washed in water for several times, and then dried.

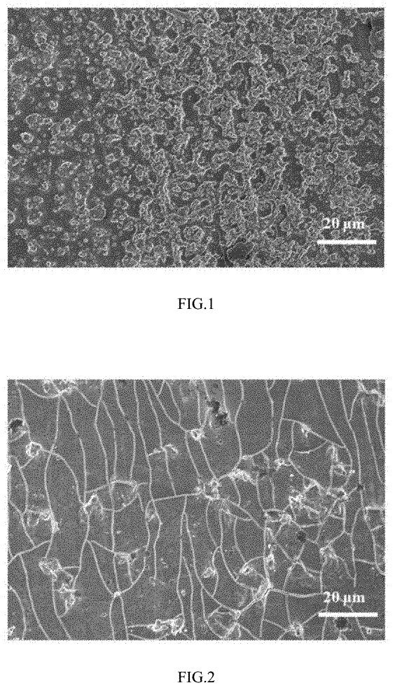

FIG. 1 is an SEM image of the morphology of the carbon steel treated with the pretreatment reagent, showing an obvious rough and porous structure. FIG. 2 is the morphology of carbon steel passivated by tannic acid under the same conditions by directly using the same concentration of tannic acid solution. It can be seen that the surface is flatter than that in FIG. 1 and has a cracked and flat morphology. The roughness test was performed by a surface profiler (Dektak150, Veeco, USA), and the results are shown in Table 1. The tensile force test of the sample under the epoxy resin cover is passed, as shown in Table 2.

TABLE 1
Roughness test results of different samples.

| Sample name | Roughness (nm) |
|---|---|
| MS | 95 |
| MS/TA | 400 |
| MS/TA-PVA | 1352 |

TABLE 2
The adhesion strength of different samples of epoxy resin.

| Sample name | Maximum pulling force (N · cm⁻²) |
|---|---|
| MS/Ep | 34.3 |
| MS/TA/Ep | 29.8 |
| MS/PVA/Ep | 115.3 |
| MS/TA-PVA/Ep | 143.8 |

### Embodiment 2

It is prepared by reflux method. 100 mL water, 5 g tannic acid (TA, Aladdin Chemical Reagent Co., Ltd.), 2 g polyvinyl alcohol type 1788 (Macklin Chemical Reagent Co., Ltd.) are mixed and refluxed for 8 hours at 90° C. The product is cooled to room temperature after refluxing. The polished and degreased Q235 carbon steel is immersed in the prepared pretreatment test solution for 3 min at 40° C., and then taken out. Put it in an oven at 60° C. to cure for 30 minutes. After curing, it is repeatedly washed in water for several times, and then dried.

The roughness test was performed by a surface profiler (Dektak150, Veeco, USA), and the results are shown in Table 3. The tensile force test of the sample under the epoxy resin cover is passed, as shown in Table 4.

TABLE 3
Roughness test results of different samples.

| Sample name | Roughness (nm) |
|---|---|
| MS | 89.3 |
| MS/TA | 562 |
| MS/TA-PVA | 1512 |

TABLE 4
The adhesion strength of different samples of epoxy resin.

| Sample name | Maximum pulling force (N · cm⁻²) |
|---|---|
| MS/Ep | 36.2 |
| MS/TA/Ep | 30.4 |
| MS/PVA/Ep | 118 2 |
| MS/TA-PVA/Ep | 130.1 |

### Embodiment 3

It is prepared by reflux method. 100 mL water, 2 mL 70 wt. % phytic acid (PA, Sinopharm Chemical Reagent Co., Ltd.), 1 g polyvinyl alcohol type 1799 (Macklin Chemical Reagent Co., Ltd.) are mixed and refluxed for 5 hours at 85° C. The product is cooled to room temperature after refluxing. The polished and degreased galvanized steel, aluminum alloy, and T2 copper are immersed in the prepared pretreatment test solution for 10 min at 25° C., and then taken out. Put it in an oven at 40° C. to cure for 30 minutes. After curing, it is repeatedly washed in water for several times, and then dried.

The roughness test results of the PA-PVA film obtained from different metal substrates are shown in Table 5, and the test results of the adhesion of the samples with respect to epoxy resin after the pretreatment of different metal substrates are shown in Table 6.

TABLE 5
Roughness test results of PA-PVA films obtained
on different metal substrates.

| Metal substrate | Roughness (nm) |
|---|---|
| Galvanized steel | 1805 |
| Aluminum alloy | 1304 |
| T2 copper | 1432 |

TABLE 6
Test results of adhesion strength of different metal
substrates relative to epoxy resin after pretreatment.

| Metal substrate | Maximum pulling force (N · cm⁻²) |
|---|---|
| Galvanized steel | 142.5 |
| Aluminum alloy | 129.4 |
| T2 copper | 135.8 |

### Embodiment 4

It is prepared by reflux method. 100 mL of water, 4 g of tannic acid (TA, Aladdin Reagent Co., Ltd.), 1 g of polyvinyl alcohol type 1788 (Macklin Chemical Reagent Co., Ltd.) are mixed and refluxed for 4 hours at 80° C. Then, the product is cooled to room temperature after refluxing and added 200 mg of urotropine corrosion inhibitor prior to use. The polished and degreased Q235 mild steel is immersed in the prepared pretreatment reagent for 30 s at 30° C., and then taken out. Put it in an oven at 60° C. to cure for 60 minutes. After curing, it is repeatedly washed in water for several times, and then dried.

The roughness test was performed by a surface profiler (Dektak150, Veeco, USA), and the results are shown in Table 7. The tensile force test of the sample under the epoxy resin cover is passed, as shown in Table 8.

TABLE 7
Roughness test results of different samples.

| Sample name | Roughness (nm) |
|---|---|
| MS | 95 |
| MS/TA | 356 |
| MS/TA-PVA | 1254 |

TABLE 8
The adhesion strength of different samples of epoxy resin.

| Sample name | Maximum pulling force (N · cm⁻²) |
|---|---|
| MS/Ep | 36.2 |
| MS/TA/Ep | 35.6 |
| MS/PVA/Ep | 116.4 |
| MS/TA-PVA/Ep | 129.6 |

What is claimed is:

1. A method for constructing an organic acid pretreatment layer with a micro-nano porous structure on a metal surface, comprising steps of:
1) refluxing a hydroxyl-rich polymer and an organic acid in water, and after cooling to room temperature, adding a corrosion inhibitor to prepare a pretreatment reagent prior to use; and
2) after a metal substrate is polished and degreasing, immersing the metal substrate in a pretreatment test solution for pretreatment; after drying and solidification, removing excess pretreatment test solution by washing with water to obtain the organic acid pretreatment layer with the micro-nano porous structure on the metal surface.

2. The method, as recited in claim 1, further comprising a step 3) preparing a subsequent coating on the organic acid pretreatment layer.

3. The method, as recited in claim 1, wherein the hydroxylated polymer in the step 1) is water-soluble polyethylene glycol, polyvinyl alcohol, polymethylcellulose, or a combination thereof.

4. The method, as recited in claim 1, wherein the organic acid in the step 1) is phytic acid, tannic acid, hydroxyethylidene diphosphonic acid, which has strong chelating coordination with metal, or a combination thereof.

5. The method, as recited in claim 1, wherein a reflux reaction temperature in the step 1) is 70-100° C., and a reflux reaction time is 3-8 hours.

6. The method, as recited in claim 1, wherein the corrosion inhibitor in the step 1) is urotropine, thiourea, benzotriazole, polyvinylpyrrolidone, zinc gluconate and sodium metavanadate, or a combination thereof.

7. The method, as recited in claim 1, wherein a pretreatment temperature in the step 2) is 20-60 ° C., and a treatment time is 0.5-15 min; a drying and curing temperature is 40-60° C., and a time is 10-30 min.

8. The method, as recited in claim 1, wherein applicable metals are iron, aluminum, zinc, copper, magnesium and alloys of the above metals.

9. The method, as recited in claim 2, wherein the subsequent coating prepared on the pretreatment layer in the step 3) comprises coating epoxy, polyurethane, alkyd and polyacrylic acid.

10. A metal with an organic acid pretreatment layer, wherein the organic acid pretreatment layer has a micro-nano porous structure and is prepared by the method according to claim 1.
